(19) United States
(12) Patent Application Publication
(10) Pub. No.: US 2007/0041503 A1
(43) Pub. Date: Feb. 22, 2007

(54) X-ray tube

(75) Inventor: Eberhard Lenz, Elangen (DE)

Correspondence Address: SCHIFF HARDIN, LLP;PATENT DEPARTMENT, 6600 SEARS TOWER, CHICAGO, IL, 60606-6473, US

(73) Assignee: Siemens Aktiengesellschaft

(21) Appl. No.: 11/504,839

(22) Filed: Aug. 15, 2006

(30) Foreign Application Priority Data
Aug. 18, 2005 (DE) 10 2005 039 188.5

(51) Int. Cl. H01J 35/08

(52) U.S. Cl. 378/143

(57) ABSTRACT

An x-ray tube has a cathode and an anode produced from a first material, the anode having a heat conductor element on the first side thereof facing away from the cathode. To improve the performance of the x-ray tube, the heat conductor element is produced from a material with a heat conductivity of at least 500 W/mK.

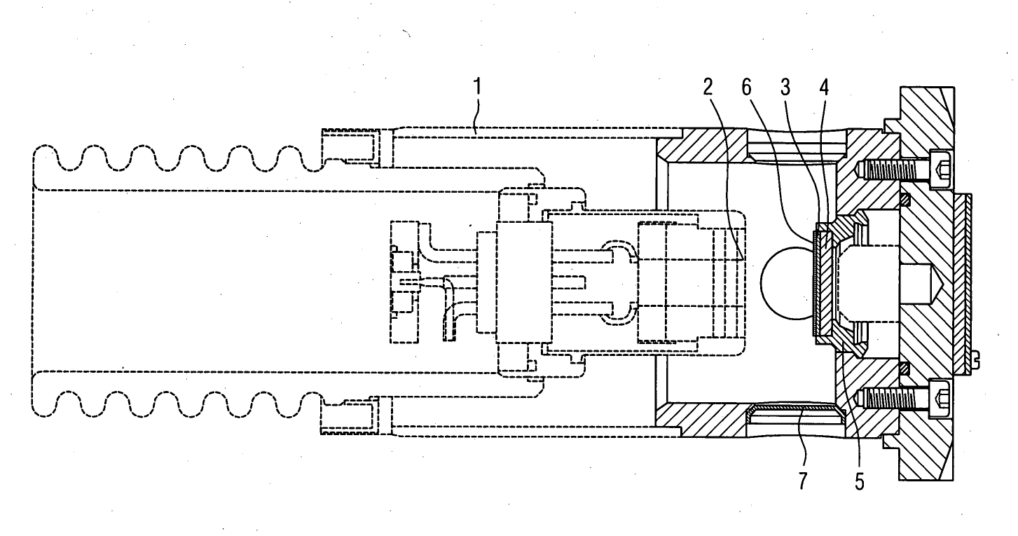

### BACKGROUND OF THE INVENTION

1. Field of the Invention

The present invention concerns an x-ray tube of the type having a cathode and an anode produced from a first material, wherein the anode, at a first side thereof facing away from the cathode, has at least sections containing a heat conductor element produced from a second material exhibiting a higher heat conductivity than said first material, for dissipating heat.

1 . Description of the Prior Art

An x-ray tube of the above general type is known. An anode made of a first material is produced, the material typically being formed from a metal exhibiting a high melting point. On a side facing away from the cathode, the anode is provided at least in sections with a layer for dissipation of heat. The layer is produced from a second material which exhibits a higher heat conductivity than the first material. Such anodes are used in conventional designs of x-ray tubes, for example in x-ray tubes with fixed anodes, rotary anodes or in rotary piston tubes.

The performance of x-ray tubes is in particular limited by the thermal capacity of the anode. To increase the thermal capacity of the anode, according to the prior art various designs are known in which it is sought to distribute the heat introduced by the decelerated electron beam over an optimally large area. X-ray tubes with rotary anodes and rotary piston tubes are examples of such designs. It has also been attempted with a number of different designs to cool the anode as efficiently as possible. An increase in the performance of x-ray tubes can thereby be achieved.

### SUMMARY OF THE INVENTION

An object of the invention to provide an x-ray tube with further improved performance.

This object is achieved according to the invention in an ex-ray tube of the type initially described wherein the second material exhibits a heat conductivity of at least 500 W/mK. A significantly improved dissipation of heat from the anode can therewith be realized. The performance of the x-ray tube can be improved by up to 15%.

In an embodiment the second material is graphite doped with titanium. At room temperature such a material exhibits a heat conductivity of at least 680 W/mK in at least two crystallographic planes. The heat conductivity of the proposed graphite is notably higher than the heat conductivity of conventional graphite or of copper. It has proven to be advantageous to orient the graphite in the heat conductor elements such that at least one crystallographic plane exhibiting the aforementioned high heat conductivity is oriented essentially perpendicularly to the first side.

In a further embodiment the second material is a composite material formed of graphite and copper with a heat conductivity of more than 800 W/mK. The composite material can also embody tube-like structures produced from graphite with a diameter of 10 to 100 nm (known as nanotubes) that are embedded in the copper. An excellent heat dissipation from the anode can be achieved with this composite material.

According to a further embodiment of the invention, the heat conductor element is accommodated in a carrier structure produced from copper. The carrier structure can be a component of the anode produced from the first material, or it can be a separate component that accommodates the heat conductor element and is mounted on the first side.

According to a further embodiment the first material is selected from the following group: Cu, Rh, Mo, Fe, Ni, Co, Cr, Ti, W or an alloy that predominantly contains one of the aforementioned metals. Such a first material exhibits a particularly high melting point and enables an operation of the anode at high temperatures.

According to a further embodiment, on its second side facing toward the cathode the anode, at least in a focal zone on that side, has a layer formed of a third material, the third material exhibits a lower vapor pressure than the first material at a temperature of 800° C. An unwanted ablation of the first material thus can be prevented given operation of the anode at high temperatures. As a result no accretions of the first material can precipitate on the x-ray exit window of the tube housing, such accretions disadvantageously absorbing x-ray radiation. The proposed x-ray tube thus can be durably operated at high anode temperatures without performance loss.

The third material is appropriately selected from the following group: SiO2, TiO₂, CrN, TaC, HfC, WC, WB, W, Re, TiB, HfB, TiAIN, TiAICN, B, Co, Ni, Ti, V, Pt, Ta. The cited compounds are characterized by a very low formation enthalpy and therewith (according to general practical experience) by a particularly low vapor pressure.

In a further embodiment, the SiO₂ can be provided with filling material produced from carbon or TiO₂. This embodiment variant is characterized by an improved stability of the third material, in particular at high temperatures. The layer can exhibit a thickness in the range of 0.2 to 1.0 μm. A thickness of the layer in the range from 0.3 to 0.8 μm has proven to be particularly advantageous.

The anode can be a fixed anode or a rotary anode that can be rotated relative to the cathode. The anode may also be a component of a rotary piston tube. Particularly high efficiencies can be achieved given a use of the inventive anode as a component of a rotary anode or of a rotary piston tube.

### DESCRIPTION OF THE DRAWING

The single figure is a side view, party in section, of an x-ray tube constructed in accordance with the principles of the present invention.

### DESCRIPTION OF THE PREFERRED EMBODIMENTS

A sectional view of an x-ray tube with a fixed anode is schematically shown in the single drawing. An anode 3 (for example produced from tungsten) is provided opposite a cathode 2 in a vacuum-sealed housing 1. On the anode 3, a heat conductor element 4 is attached on the first side thereof facing away from the cathode 2. The heat conductor element 4 is composed of a material that exhibits a higher heat conductivity in comparison to the anode material. The heat conductor element 4 can be produced, for example, from graphite doped with titanium with a heat conductivity of >650 W/mK. Insofar as the heat conductor element 4 is anisotropic with regard to its heat conductivity, it is attached on the anode 3 such that the direction of the maximum heat conductivity proceeds approximately perpendicularly to the surface of the anode 3.

On its second side facing toward the cathode 2, the anode 3 is provided with a layer 6 produced, for example, from TaC or HfC. The material used for production of the layer 6 exhibits a lower vapor pressure at 800° than the material used for production of the anode 3. As a consequence, ablation of anode material and its unwanted precipitation thereof on the x-ray exit window 7 are prevented.

The layer 6 preferably exhibits a thickness of 300 to 700 nm. For example, it can be applied on the anode 3 by a Sol-Gel method or a PVD method.

Fibers produced from graphite are also suitable for production of the heat conductor element 4. An example of suitable fibers is offered by the company Cytec Engineered Materials GmbH under the mark “THORNEL CARBON FIBRES”. Graphite fibers offered by the same company under the mark “THERMALGRAF” are likewise suitable. Plates can be produced from the aforementioned fibers, such plates in turn forming the starting material for production of the heat conductor element 4.

Although modifications and changes may be suggested by those skilled in the art, it is the intention of the inventor to embody within the patent warranted hereon all changes and modifications as reasonably and properly come within the scope of his contribution to the art.

1. An x-ray tube comprising:
a cathode;
an anode comprising a first material, said anode having a side facing away from the cathode; and
a heat conductor element disposed at least in a section of said side of said anode facing away from the cathode, said heat conductor element comprising a second material exhibiting a higher heat conductivity than said first material, for dissipating heat from said anode, said second material exhibiting a heat conductivity of at least 500 W/mK.

2. An x-ray tune as claimed in claim 1 wherein said second material comprises graphite doped with titanium.

3. An x-ray tune as claimed in claim 1 wherein said second material is a composite material comprising graphite and copper, and has a heat conductivity of more than 800 W/mK.

4. An x-ray tune as claimed in claim 3 wherein said composite material comprises tubular graphite structures embedded in copper, each tubular structure having a diameter in a range between 10 nm and 100 nm.

5. An x-ray tune as claimed in claim 1 comprising a carrier structure at said side of said anode facing away from said cathode, said carrier structure containing said heat conductor element and being comprised of copper.

6. An x-ray tune as claimed in claim 1 wherein said first material is a material selected from the group consisting of Cu, Rh, Mo, Fe, Ni, Co, Cr, Ti, W, and respective alloys predominately containing one of Cu, Rh, Mo, Fe, Ni, Co, Cr, Ti, W.

7. An x-ray tune as claimed in claim 1 wherein said anode has a side facing toward said cathode with focus zone thereon struck by electrons emitted by said cathode, said focus zone being comprised of a third material, said third material exhibiting a lower vapor pressure than said first material at a temperature of 800°0 C.

8. An x-ray tune as claimed in claim 7 wherein said third material is a material selected from the group consisting of SiO₂, TiO₂, CrN, TaC, HfC, WC, WB, W, Re, TiB, HfB, TiAIN, TiAICN, B, Co, Ni, Ti, V, Pt, Ta.

9. An x-ray tune as claimed in claim 7 wherein said third material comprises SiO₂ with filling material selected from the group consisting of C and TiO₂.

10. An x-ray tune as claimed in claim 7 wherein said third material forms a layer on said side of said anode facing toward said cathode, said layer having a layer thickness in range between 0.2 μm and 1.0 μm.

11. An x-ray tune as claimed in claim 1 comprising a housing containing said cathode and said anode, and wherein said anode is fixedly mounted in said housing relative to said cathode.

12. An x-ray tune as claimed in claim 1 comprising a housing containing said cathode and said anode, and wherein said anode is rotatably mounted in said housing relative to said cathode.

13. An x-ray tune as claimed in claim 1 comprising a housing that is rotatable relative to said cathode, forming a rotary piston, and wherein said anode is a component of said housing that rotates therewith.
